(19) United States
(12) Patent Application Publication
(10) Pub. No.: US 2025/0337189 A1
(43) Pub. Date: Oct. 30, 2025

(54) Connector and Connector Assembly

(71) Applicant: Tyco Electronics (Shanghai) Co., Ltd., Shanghai (CN)

(72) Inventors: Yang (Leon) Zou, Shanghai (CN); Liming (Eric) Wang, Shanghai (CN); Xinxin (Daisy) Li, Shanghai (CN); Zebin (Donnie) Tang, Shanghai (CN); Zhenyu (Richard) Chen, Shanghai (CN)

(73) Assignee: Tyco Electronics (Shanghai) Co., Ltd., Shanghai (CN)

(21) Appl. No.: 19/188,230

(22) Filed: Apr. 24, 2025

(30) Foreign Application Priority Data
Apr. 24, 2024 (CN) 202420870814.X

(51) Int. Cl. H01R 13/52; H01R 24/20

(52) U.S. Cl. CPC H01R 13/5205; H01R 24/20

(57) ABSTRACT

A connector includes a housing having a mating end and a wiring end opposite the mating end. The wiring end has a first cable passage filled with a first silica gel. A first cable is inserted into the first cable passage and connects to a first terminal installed in the housing. The mating end has a mating cavity filled with a second silica gel at an end adjacent the first cable passage. A mating connector is mated with the connector when inserted into the mating end.

### CROSS-REFERENCE TO RELATED APPLICATION

This application claims the benefit of the filing date under 35 U.S.C. § 119(a)-(d) of Chinese Patent Application No. CN 202420870814.X, filed on Apr. 24, 2024.

### FIELD OF THE INVENTION

Embodiments of the present disclosure relate to a connector, and more particularly, to a connector and a connector assembly including the connector.

### BACKGROUND OF THE INVENTION

A sealed connector having good waterproof and dustproof performance can have a wider range of applications than ordinary connectors, especially in environments where long-term operation is required in harsh conditions. In related art, waterproof sealing solutions for connectors typically involve assembling rubber seal rings or gaskets after crimping a terminal, which requires separate customized seal rings or gaskets for different types of connectors. Thus, mold production of the seal rings or gaskets is required, increasing the cost, prolonging the development cycle, and leading to low assembly efficiency of typical connectors.

### SUMMARY OF THE INVENTION

A connector includes a housing having a mating end and a wiring end opposite the mating end. The wiring end has a first cable passage filled with a first silica gel. A first cable is inserted into the first cable passage and connects to a first terminal installed in the housing. The mating end has a mating cavity filled with a second silica gel at an end adjacent the first cable passage. A mating connector is mated with the connector when inserted into the mating end.

### BRIEF DESCRIPTION OF DRAWINGS

The invention will now be described by way of example with reference to the accompanying figures, of which:

FIG. 1 is a schematic view of a connector assembly according to an exemplary embodiment in a disassembled state;

FIG. 2 is a schematic cross-sectional view of the connector assembly of FIG. 1; and

FIG. 3 is a schematic cross-sectional view of the connector assembly of FIG. 1 after being assembled.

### DETAILED DESCRIPTION

Although the present disclosure will be fully described with reference to the drawings containing embodiments of the present disclosure, it should be understood that those skilled in the art may modify the present disclosure described herein while obtaining the technical effect of the present disclosure. Therefore, it is necessary to understand that the description below is a broad disclosure for those skilled in the art and is not intended to limit the exemplary embodiments described in the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

It should be noted that, as used herein, the words “comprise” or “include” do not exclude other elements or steps, and the words “a” or “an” do not exclude a plurality of elements or steps. In addition, any reference numerals in the drawings should not be interpreted as a limitation to the scope of the present disclosure.

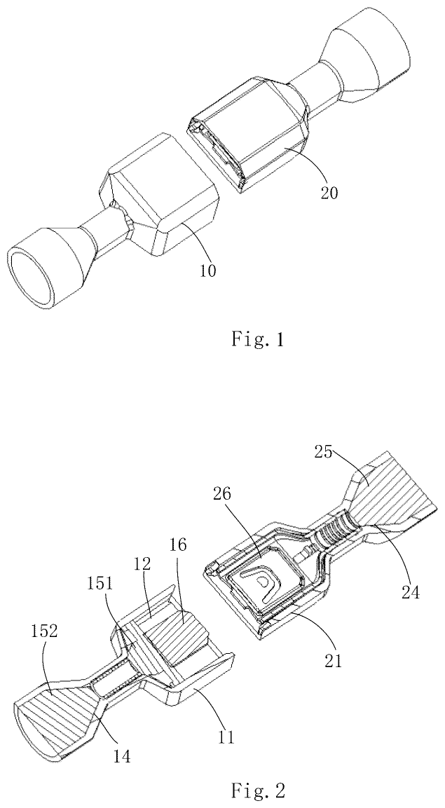

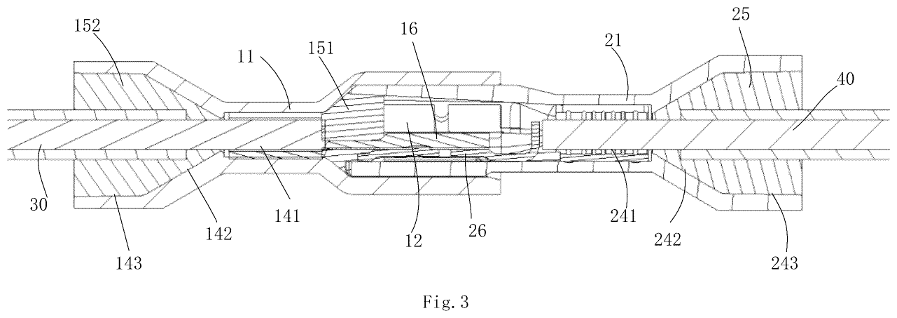

An exemplary embodiment of a connector 10 is now described with reference to FIGS. 1-3. As shown in FIGS. 2-3, the connector 10 comprises a housing 11. The housing 11 includes a mating end and a wiring end opposite to the mating end. The wiring end includes a first cable passage 14 into which a first cable 30 is inserted so as to be connected with a first terminal 16 installed in the housing 11. The first cable passage 14 is filled with a passage silica gel 152, to prevent water, moisture and other substances from entering the connector 10 through the first cable passage 14, so as to improve the sealing performance of the connector 10. Similarly, as shown in FIG. 3, the mating end is formed with a mating cavity 12 for insertion of a mating connector 20 mated with the connector 10. As shown in FIGS. 2-3, the mating cavity 12 is filled with a cavity silica gel 151 at one end near the first cable passage 14, to prevent water, moisture and other substances from entering the connector 10 through a gap between the connector 10 and the mating connector 20, so as to further improve the sealing performance. Throughout the present application, the passage silica gel 152 may also be referred to as a first silica gel and the cavity silica gel 151 may also be referred to as a second silica gel.

During assembly, uncured silica gel may be poured into the first cable passage 14 of the housing 11. The uncured silica gel 152 is cured within the first cable passage 14 to be in a jelly-like state, which then is bonded with the housing 11. In this way, once the first cable 30 is inserted, the waterproof sealing functionality is achieved. The connector 10 according to the embodiments of the present disclosure adopts a pre-sealing solution, that is, the waterproof sealing function is realized by filling the passage silica gel 152 before assembling the first cable 30, and the sealing effect may be realized after inserting the first cable 30, which is convenient, and improves the assembling efficiency by a client. Furthermore, the pre-sealing solution can be applied to various types of connectors, such as flag-shaped connectors and multi-pin connectors, and adapted to a larger cable diameter span with better compatibility.

Since the silica gel 152 is as soft as jelly after curing and the cured surface is naturally sticky, the silica gel 152 may be easily adhered to most substrates without a primer, enhancing physical adhesion. This makes it easy to bond the silica gel 152 with an inner surface of the first cable passage 14. Moreover, the silica gel 152 is extremely soft, allowing the cable to be easily inserted later. Additionally, the natural stickiness of the silica gel 152 has regenerative properties, enabling it to be adhered to subsequently inserted cables, significantly improving the sealing performance of the connector 10.

As shown in FIG. 3, the first cable passage 14 includes a first section 141 close to the mating end, a third section 143 away from the mating end, and a second section 142 connecting the first section 141 and the third section 143. A size of the third section 143 is greater than a size of the first section 141, and the size of the first section 141 is adapted to an overall size of the first cable 30. The passage silica gel 152 is filled within the second section 142 and the third section 143.

In another embodiment, the inner surface of the first cable passage 14 being in contact with the silica gel 152 is formed with a pattern to increase a contact force between the silica gel 152 and the inner surface of the first cable passage 14, thereby preventing the silica gel 152 from escaping from the first cable passage 14.

In another embodiment, the connector 10 further includes a first stop portion extending radially inward from the inner surface of the first cable passage 14, to prevent the silica gel 152 from escaping from the first cable passage 14. For example, the first stop portion is formed at the third section 143 of the first cable passage 14 (e.g., at an end of the third section 143 away from the first section 141).

In another embodiment, an inner surface of the mating cavity 12 being in contact with the cavity silica gel 151 is formed with a pattern, to increase a contact force between the silica gel 151 and the inner surface of the mating cavity 12, thereby preventing the silica gel 151 from escaping from the mating cavity 12.

In another embodiment, the connector 10 further includes a second stop portion extending radially inward from the inner surface of the mating cavity 12, to prevent the cavity silica gel 151 from escaping from the mating cavity 12. It should be noted that a position of the second stop portion should be provided where it does not affect the insertion of the mating connector 20 into the mating cavity 12.

An exemplary embodiment of a connector assembly is now described with reference to FIGS. 1-3. The connector assembly comprises the abovementioned connector 10, and a mating connector 20 configured to be inserted into the mating cavity 12 of the connector 10.

As shown in FIGS. 1-3, the mating connector 20 includes a mating housing 21. The mating housing 21 includes a first end configured to be inserted into the mating cavity 12 of the connector 10, and a second end opposite to the first end. As shown in FIGS. 2-3, the second end has a second cable passage 24 into which a second cable 40 is inserted so as to be connected with a mating terminal 26 installed in the mating housing 21. The second cable passage 24 is filled with a mating silica gel 25, to prevent water, moisture and other substances from entering the mating connector 20 through the second cable passage 24, so as to further improve the sealing performance of the mating connector 20 and the connector assembly. Throughout the present application, the mating silica gel 25 may also be referred to as a third silica gel 25.

As shown in FIG. 3, the second cable passage 24 includes a first section 241 close to the first end of the mating housing 21, a third section 243 away from the first end of the mating housing 21, and a second section 242 connecting the first section 241 and the third section 243. A size of the third section 243 is greater than a size of the first section 241, and the size of the first section 241 is adapted to an overall size of the first cable 30. The mating silica gel 25 is filled within the second section 242 and the third section 243.

In an embodiment, an inner surface of the second cable passage 24 being in contact with the mating silica gel 25 is formed with a pattern, to increase a contact force between the silica gel 25 and the inner surface of the second cable passage 24, thereby preventing the mating silica gel 25 from escaping from the second cable passage 24.

In an embodiment, the mating connector 20 further comprises a third stop portion extending radially inward from the inner surface of the second cable passage 24, to prevent the mating silica gel 25 from escaping from the second cable passage 24. For example, the third stop portion is formed at the third section 243 of the second cable passage 24 (e.g., at an end of the third section 243 away from the first section 241).

The connector 10 and the connector assembly provided by the foregoing exemplary embodiments of the present disclosure adopt a pre-sealing solution. That is, the waterproof sealing function is realized by filling the silica gel 25, 151, 152 before assembling the respective cable 30, 40, and the sealing effect may be realized after inserting the respective cable 30, 40, which is convenient, and improves the production efficiency by the client. Furthermore, the pre-sealing solution can be applied to a variety of types of connectors, and adapted to a larger cable diameter span with better compatibility.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described in detail with reference to the accompanying drawings, it should be appreciated that the disclosed embodiments in the accompanying drawings are intended to illustrate embodiments of the present disclosure by way of example, and should not be construed as limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

1. A connector, comprising:
a housing having a mating end and a wiring end opposite the mating end, the wiring end has a first cable passage filled with a first silica gel, a first cable is inserted into the first cable passage and connects to a first terminal installed in the housing, the mating end has a mating cavity filled with a second silica gel at an end adjacent the first cable passage, a mating connector is mated with the connector when inserted into the mating end.

2. The connector of claim 1, wherein the first cable passage has a first section adjacent to the mating end, a third section spaced apart from the mating end, and a second section connecting the first section and the third section, a size of the third section of the first cable passage is greater than a size of the first section of the first cable passage.

3. The connector of claim 2, wherein the first silica gel is filled in the second section and the third section of the first cable passage.

4. The connector of claim 3, wherein an inner surface of the first cable passage contacting the first silica gel is formed with a pattern.

5. The connector of claim 4, further comprising a first stop portion extending radially inward from the inner surface of the first cable passage.

6. The connector of claim 5, wherein the first stop portion is formed at an end of the third section spaced apart from the first section.

7. The connector of claim 1, wherein an inner surface of the mating cavity contacting the second silica gel is formed with a pattern.

8. The connector of claim 7, further comprising a second stop portion extending radially inward from the inner surface of the mating cavity.

9. The connector of claim 1, wherein the first silica gel and the second silica gel are cured in the housing and bonded with the housing after curing.

10. A connector assembly, comprising:
a connector including a housing, the housing has a mating end and a wiring end opposite the mating end, the wiring end has a first cable passage filled with a first silica gel, a first cable is inserted into the first cable passage and connects to a first terminal installed in the housing, the mating end has a mating cavity filled with a second silica gel at an end adjacent the first cable passage; and
a mating connector inserted into the mating cavity of the connector.

11. The connector assembly of claim 10, wherein the mating connector includes a mating housing having a first end inserted into the mating cavity of the connector and a second end opposite the first end, the second end has a second cable passage filled with a third silica gel, a second cable is inserted into the second cable passage and connects with a mating terminal installed in the mating housing.

12. The connector assembly of claim 11, wherein the second cable passage has a first section adjacent to the first end of the mating housing, a third section spaced apart from the first end of the mating housing, and a second section connecting the first section and the third section, a size of the third section of the second cable passage is greater than a size of the first section of the second cable passage.

13. The connector assembly of claim 12, wherein the third silica gel is filled in the second section and the third section of the second cable passage.

14. The connector assembly of claim 13, wherein an inner surface of the second cable passage contacting the third silica gel is formed with a pattern.

15. The connector assembly of claim 14, further comprising a third stop portion extending radially inward from the inner surface of the second cable passage.

16. The connector assembly of claim 15, wherein the third stop portion is formed at an end of the third section of the second cable passage spaced apart from the first section of the second cable passage.
